(19) United States
(12) Patent Application Publication
(10) Pub. No.: US 2024/0276033 A1
(43) Pub. Date: Aug. 15, 2024

(54) DYNAMIC INSERTION OF INTERACTIVE CONTENT IN A MEDIA CONTENT

(71) Applicant: G-Mana LTD, Natanya (IL)

(72) Inventors: Eran YAHALOMI, Natanya (IL); Yonatan AYALON, Afula (IL); Arie WEIZEL, Petach Tiqwa (IL)

(21) Appl. No.: 18/568,059

(22) PCT Filed: May 30, 2022
(86) PCT No.: PCT/IL2022/050575

§ 371 Date: Dec. 7, 2023

(30) Foreign Application Priority Data
Jun. 8, 2021 (IL) 283807

(51) Int. Cl. H04N 21/234; H04N 21/81

(52) U.S. Cl. CPC H04N 21/23424; H04N 21/812; H04N 21/8173

(57) ABSTRACT

Some embodiments are directed to a server including a processor and memory circuitry configured to obtain a media content including at least one of an audio content and a video content, obtain enrichment data informative of a given enrichment content associated with the media content, for a computer-implemented media player of a first media player type, use the media content and the enrichment data to generate augmented data. The augmented data can include data informative of the media content, playable by the media player of the first media player type, and a software module executable by the media player of the first media player type. Execution of the software module by the media player enables execution of the given enrichment content by the media player. A device configured to implement a media player of a given media player type can be operative to communicate with the server.

### CROSS-REFERENCE TO A RELATED APPLICATION

This application is a national phase filing under 35 C.F.R. § 371 of and claims priority to PCT Patent Application No. PCT/IL2022/050575, filed on May 30, 2022, which claims the priority benefit under 35 U.S.C. § 119 of Israeli Patent Application No. 283807, filed on Jun. 8, 2021, the contents of each of which are hereby incorporated in their entireties by reference.

### TECHNOLOGICAL FIELD

The invention is in the field of insertion of content within a media content, such as (for example) insertion of interactive advertisements within a media content.

### BACKGROUND

Server-side ad-insertion is a technology to insert ad content dynamically into media content, such as a video content, which is then transmitted to a user's device.

Prior-art solutions face various technical challenges. One of these technical challenges is the difficulty to cope efficiently with the various types of devices and/or media players which receive the media content.

Prior-art solutions are unable to properly solve these technical challenges: these solutions are complex, not scalable, not flexible, not adaptive, often difficult to implement and are demanding in terms of memory and CPU usage.

Therefore, there is a need to provide new methods and systems in the field of content insertion (such as ad content) within a media content.

### SUMMARY

In accordance with certain aspects of the presently disclosed subject matter, there is provided a server comprising a processor and memory circuitry (PMC) configured to obtain a media content comprising at least one of an audio content and a video content, obtain enrichment data informative of a given enrichment content associated with the media content, for a computer-implemented media player of a first media player type, use the media content and the enrichment data to generate augmented data, wherein the augmented data comprises data informative of the media content, playable by the media player of the first media player type, and a software module executable by the media player of the first media player type, wherein execution of at least part of the software module by the media player enables execution of the given enrichment content by the media player.

In addition to the above features, the server according to this aspect of the presently disclosed subject matter can optionally comprise one or more of features (i) to (xxvi) below, in any technically possible combination or permutation:
i. the software module comprises an executable code, wherein execution of at least part of the executable code by the media player of the first media player type enables execution of the given enrichment content by the media player;
ii. the PMC is configured to obtain a media content comprising at least one of an audio content and a video content, obtain enrichment data informative of a given enrichment content associated with the media content, for each given user device of a plurality of different user devices, obtaining information on a given type of a media player implemented at the given user device, wherein at least two user devices implement a media player of a different type, for each given type of media player, use the media content and the enrichment data to generate augmented data, wherein the augmented data comprises data informative of the media content, playable by a media player of the given media player type and a software module executable by a media player of the given media player type, wherein execution of at least part of the software module by the media player enables execution of the given enrichment content by the media player;
iii. the server is configured to perform a textual analysis of the enrichment data to detect at least one predefined function informative of said given enrichment content;
iv. the server is configured to obtain data informative of a main media content comprising at least one of an audio content and a video content, obtain a media content comprising at least one of an audio content and a video content, wherein a duration of the media content is below a predefined threshold, obtain enrichment data informative of a given enrichment content associated with the media content, for a computer-implemented media player of a first media player type, use the media content and the enrichment data to generate augmented data, wherein the augmented data comprises data informative of the media content, playable by the media player of the first media player type, a software module executable by the media player of the first media player type, wherein execution of at least part of the software module by the media player enables execution of the given enrichment content by the media player, and insert data informative of the augmented data within the data informative of the main media content;
v. the predefined threshold is selected to ensure that the media content is not noticeable by a human when the media player plays the main media content;
vi. the PMC is operative to communicate with a database, storing, for each given media player type of a plurality of different media player types of media players, a given software module adapted to said given media player type, wherein, for a computer-implemented media player of the first media player type, the PMC is configured to obtain the software module using a first software module of the database, wherein the first software module is adapted to the first media player type, wherein execution of at least part of the software module by the media player enables execution of the enrichment content by the media player;
vii. obtaining the software module using the first software module comprises (a) or (b): (a) extracting the first software module from the database, wherein the software module corresponds to the first software module; (b) generating the software module using the first software module and the enrichment data;
viii. the PMC is operative to communicate with a database storing, for each given type of enrichment content of a plurality of types of enrichment content, a given software module enabling the media player of the first media player type to execute an enrichment content of the given type of enrichment content, wherein the given enrichment content is of a first type of enrichment content, wherein the PMC is configured to obtain the software module using a first software module of the database, wherein the first software module is adapted to the first type of enrichment content, wherein execution of at least part of the software module by the media player enables execution of the given enrichment content by the media player;
ix. obtaining the software module using the first software module comprises (a) or (b): (a) extracting the first software module from the database, wherein the software module corresponds to the first software module; (b) generating the software module using the first software module and the enrichment data.
x. the PMC is configured to determine that the given enrichment content is of the first type of enrichment content;
xi. the PMC is operative to communicate with a database storing, for each given media player type of a plurality of different media player types and for each given type of enrichment content of a plurality of types of enrichment content, a given software module enabling a media player of the given media player type to execute an enrichment content of the given type of enrichment content, wherein the given enrichment content is of a first type of enrichment content, wherein the PMC is configured to obtain the software module using a first software module of the database, wherein the first software module is adapted to the first media player type and to the first type of enrichment content, wherein execution of at least part of the software module by the media player enables execution of the given enrichment content by the media player;
xii. obtaining the software module using the first software module comprises (a) or (b): (a) extracting the first software module from the database, wherein the software module corresponds to the first software module; (b) generating the software module using the first software module and the enrichment data;
xiii. the PMC is configured to determine that the given enrichment content is of the first type of enrichment content;
xiv. the PMC is operative to communicate with a database storing, for each given media player type of a plurality of different media player types and for each given type of enrichment content of a plurality of types of enrichment content, a given software module enabling a media player of the given media player type to execute an enrichment content of the given type of enrichment content, wherein the given enrichment content is of a first type of enrichment content, wherein the PMC is configured to obtain the software module using a first software module of the database, wherein the first software module is adapted to the first media player type and to the first type of enrichment content, wherein execution of at least part of the software module by the media player enables execution of the given enrichment content by the media player;
xv. obtaining the software module using the first software module comprises (a) or (b): (a) extracting the first software module from the database, wherein the software module corresponds to the first software module; (b) generating the software module using the first software module and the enrichment data.
xvi. the PMC is configured to determine that a media player of a user, to which the media content and the given enrichment content, or data informative thereof, is to be transmitted, is of the first media player type;
xvii. the augmented data comprises MPEG data, wherein the MPEG data comprises the data informative of the media content and metadata storing the software module;
xviii. the PMC is configured to transmit the augmented data, or data enabling access to the augmented data, to the media player of the first media player type, wherein the augmented data stores the software module as metadata, wherein the media player of the first media player type is operative to execute metadata in the augmented data;
xix. execution of at least part of the software module by the media player of the first media player type of a user enables execution of the given enrichment content by the media player, wherein execution of the given enrichment content enables an interaction with the user;
xx. execution of at least part of the software module by the media player of the first media player type of a user enables execution of the given enrichment content by the media player, wherein execution of the given enrichment content enables monitoring of a behavior of the user during playing of the media content by the media player;
xxi. the media content comprises advertisement content;
xxii. the given enrichment content is encoded according to a Video Ad Serving Template or Video Player-Ad Interface Definition;
xxiii. the given enrichment content is not encoded according to a Video Ad Serving Template and is not encoded according to Video Player-Ad Interface Definition;
xxiv. the PMC is configured to obtain data informative of a main media content to be streamed, the main media content comprising at least one of a video content and an audio content, insert, within the data, data informative of the augmented data, to obtain updated data; and
xxv. the media player of the first media player type is operative to execute a computer-implemented function enabling detection of the software module in the augmented data, and execution of said software module; and
xxvi. the PMC is operative to communicate with a database storing, for each given media player type of a plurality of different media player types and for at least one given type of enrichment content, a given software module enabling a media player of the given media player type to execute an enrichment content of the given type of enrichment content, wherein the PMC is operative to update the database to store, for each given media player type of the plurality of different media player types, for a new type of enrichment content, a new software module enabling a media player of the given media player type to execute an enrichment content of the new type of enrichment content.

In accordance with certain aspects of the presently disclosed subject matter, there is provided a device comprising a processor and memory circuitry (PMC) configured to implement a media player of a given media player type, wherein the media player is configured to receive augmented data comprising a media content playable by the media player of the given media player type, wherein the media content comprises at least one of an audio content and a video content, and a software module informative of a given enrichment content, wherein the software module comprises an executable code executable by the media player of the given media player type, play the media content, and execute at least part of the executable code, wherein execution of the executable code by the media player enables execution of the given enrichment content by the media player.

In addition to the above features, the server according to this aspect of the presently disclosed subject matter can optionally comprise one or more of features (xxvii) to (xxviii) below, in any technically possible combination or permutation:
xxvii. the media player of the first media player type is operative to execute a computer-implemented function enabling detection of the software module in the augmented data, and execution of said software module; and
xxviii. the executable code is executable only by a limited subset of media player types, the subset of media player types comprising the given media player type.

In accordance with certain aspects of the presently disclosed subject matter, there is provided a method comprising, by a processor and memory circuitry (PMC), obtaining a media content comprising at least one of an audio content and a video content, obtaining enrichment data informative of a given enrichment content associated with the media content, for a computer-implemented media player of a first media player type, using the media content and the enrichment data to generate augmented data, wherein the augmented data comprises data informative of the media content, playable by the media player of the first media player type, and a software module executable by the media player of the first media player type, wherein execution of at least part of the software module by the media player enables execution of the given enrichment content by the media player.

In addition to the above features, the method according to this aspect of the presently disclosed subject matter can optionally comprise one or more of features (i) to (xxvi) as described above.

In accordance with certain aspects of the presently disclosed subject matter, there is provided a non-transitory storage device readable by a machine, tangibly embodying a program of instructions executable by the machine to perform operations as described with reference to the method above.

In accordance with certain aspects of the presently disclosed subject matter, there is provided a method comprising, by a processor and memory circuitry (PMC), receiving, by a media player of a given media player type, augmented data comprising a media content playable by the media player of the given media player type, wherein the media content comprises at least one of an audio content and a video content, a software module informative of a given enrichment content, wherein the software module comprises an executable code executable by the media player of the given media player type, playing the media content by the media player, and executing at least part of the executable code by the media player, wherein execution of the executable code by the media player enables execution of the given enrichment content by the media player.

In addition to the above features, the method according to this aspect of the presently disclosed subject matter can optionally comprise one or more of features (xxvii) to (xxviii) as described above.

In accordance with certain aspects of the presently disclosed subject matter, there is provided a non-transitory storage device readable by a machine, tangibly embodying a program of instructions executable by the machine to perform operations as described with reference to the method above.

According to some embodiments, the proposed solution is able to insert content (such as, but not limited to, ad content) in an efficient and simple way within a media content such that it can be executed by a desired type of device and/or desired type of media player among various types of devices and/or types of media players.

According to some embodiments, the proposed solution requires only small modifications of current media players in order to support various types or formats of content, such as (but not limited to) interactive ad content.

According to some embodiments, the proposed solution enables executing, at the user's device, various types of enrichment contents which enrich the experience of the user watching a media content and/or improve monitoring of the user during watching of a media content.

According to some embodiments, the proposed solution ensures compatibility of the media player of a user with various types of enrichment content (such as, but not limited to, various types of interactive ad content), without requiring substantial increase of the amount of memory and CPU used by the user's device.

According to some embodiments, the proposed solution performs manipulations mainly at the server's side and is therefore transparent to the user. As a consequence, this decreases memory and CPU usage at the user's side with respect to prior-art solutions.

According to some embodiments, the proposed solution is scalable. In particular, the solution easily adapts to new types of user's devices and/or new types of media players and/or new types of ad content and/or new types of interaction/enrichment content of a media content, without requiring deep modifications at the user's side.

According to some embodiments, the proposed solution is able to insert various types of interactive ad contents (enabling e.g. interaction with the user or other creative experience) within a media content.

According to some embodiments, the proposed solution offers to publishers of content the possibility of enriching their content with new creative content, without requiring modification of the media player at the user's side for each new creative content.

According to some embodiments, the proposed solution can rely on an existing media protocol, such as (but not limited to) MPEG/MP4, to insert various types of contents (e.g. interactive content) readable by various types of media players.

According to some embodiments, the proposed solution creates new perspectives in the field of ad insertion, since it enables insertion of various types of creative ad content while being compatible with different types of devices and/or media players. Therefore, it improves the user's experience and the impact of the ad content on the audience.

According to some embodiments, the proposed solution is not only useful in the field of streaming of ad content, but also in the field of streaming of different high value contents enabling a particular user's experience.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 illustrates an architecture of one or more systems according to some embodiments of the invention;

FIG. 1A illustrates an embodiment of augmented data to be transmitted to a user's device implementing a media player;

FIG. 2 illustrates an embodiment of a database storing different software modules for different types of media players;

FIG. 2A illustrates a non-limitative example of the database of FIG. 2;

FIG. 3 illustrates an embodiment of a database storing different software modules for different types of enrichment content;

FIG. 3A illustrates a non-limitative example of the database of FIG. 3;

FIG. 4 illustrates an embodiment of a database storing different software modules for different types of media players and for different types of enrichment content;

FIG. 4A illustrates a non-limitative example of the database of FIG. 4;

FIG. 5 illustrates an embodiment of a method of transmitting augmented data specifically adapted to a media player of a user, the augmented data including a media content and a software module enabling executing of an enrichment content;

FIG. 5A illustrates a non-limitative example of a selection of a relevant software module in a database;

FIG. 5B illustrates a non-limitative example of a database storing software modules with different parameter values for different types of enrichment content;

FIG. 5C illustrates an embodiment of a method of transmitting augmented data specifically adapted to a media player of each of a plurality of users, the augmented data including a media content and a software module enabling executing of an enrichment content by the media player of the user;

FIG. 5D illustrates an embodiment of a method of inserting a media content with enrichment content within a main media content;

FIG. 6 illustrates an embodiment of a method of updating a database storing software modules for a plurality of types of enrichment content, with a new type of enrichment content;

FIG. 6A illustrates an embodiment of a method of inserting enrichment content within a main media content to be streamed;

FIG. 6B illustrates an example of the method of FIG. 6A, at the user's side;

FIGS. 7 and 7A illustrate an example of creating PSI (Program-Specific Information) tables for a MPEG file comprising the media content and the enrichment content as metadata;

FIG. 8 illustrates an embodiment of an architecture of a media player of a user;

FIG. 9 illustrates an embodiment of a method of executing media content and enrichment content by a media player of a user;

FIG. 10 illustrates a non-limitative example of a manifest; and

FIG. 10A illustrates a non-limitative example of a manifest updated with a link to augmented data including a media content and a software module enabling executing of an enrichment content by the media player of the user.

### DETAILED DESCRIPTION OF EMBODIMENTS

In the following detailed description, numerous specific details are set forth in order to provide a thorough understanding of the invention. However, it will be understood by those skilled in the art that the presently disclosed subject matter may be practiced without these specific details. In other instances, well-known methods have not been described in detail so as not to obscure the presently disclosed subject matter.

The term “processor and memory circuitry” (PMC) as disclosed herein should be broadly construed to include any kind of electronic device with data processing circuitry, which includes for example a computer processing device operatively connected to a computer memory (e.g. digital signal processor (DSP), a microcontroller, a field programmable gate array (FPGA), and an application specific integrated circuit (ASIC), etc.) capable of executing various data processing operations.

Unless specifically stated otherwise, as apparent from the following discussions, it is appreciated that throughout the specification discussions utilizing terms such as “obtaining”, “generating”, “determining”, “using”, “executing”, “extracting”, “communicating”, “transmitting”, “selecting”, “inserting”, “receiving”, “playing” or the like, refer to the action(s) and/or process(es) of a processor and memory circuitry that manipulates and/or transforms data into other data, said data represented as physical, such as electronic, quantities and/or said data representing the physical objects.

It can encompass a single processor or multiple processors, which may be located in the same geographical zone or may, at least partially, be located in different zones and may be able to communicate together.

Embodiments of the presently disclosed subject matter are not described with reference to any particular programming language. It will be appreciated that a variety of programming languages may be used to implement the teachings of the presently disclosed subject matter as described herein.

The invention contemplates a computer program being readable by a computer for executing one or more methods of the invention. The invention further contemplates a machine-readable memory tangibly embodying a program of instructions executable by the machine for executing one or more methods of the invention.

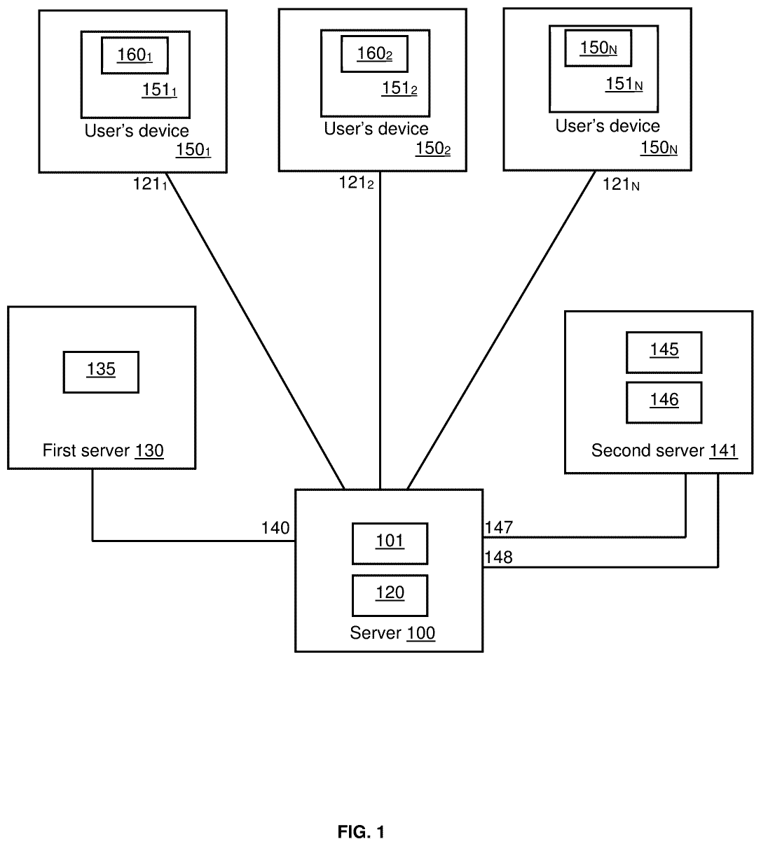

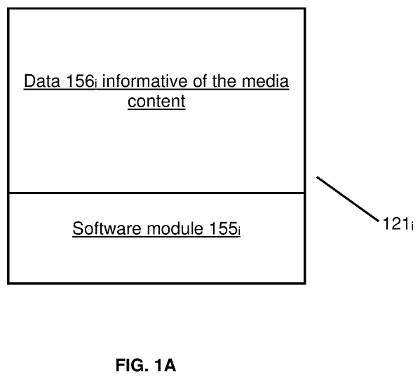

Attention is drawn to FIG. 1.

FIG. 1 depicts a server 100 which comprises processing capabilities and storage capabilities. In particular, server 100 can comprise a processing and memory circuitry (PMC) 101. In some embodiments, server 100 can include virtual processing resources, such as at least one virtual machine (VM).

A virtual machine (VM) is an emulation of a computer system. Virtual machines are based on computer architectures and provide functionality of a physical computer. Virtual machines generally include computer files that run on a physical computer (or server, or a plurality of computers/servers) and behave like a physical server or computer. Like physical computers, they run applications and an operating system.

In some embodiments, server 100 can include a combination of hardware (e.g. hardware processor and memory) and software (a virtual machine).

In some embodiments, server 100 is a SSAI server, operative to perform server-side ad insertion (also called dynamic ad insertion, or ad stitching). This is, however, not limitative.

Server 100 comprises a memory storing a database 120 and/or is operative to communicate with a memory storing the database 120. Examples of content stored in the database 120 will be described hereinafter.

Server 100 is operative to communicate (using wire and/or wireless communication) with a first server 130. The first server 130 also comprises a processor and memory circuitry 135. In some embodiments, the first server 130 can include virtual processing resources, such as at least one virtual machine (VM), or a combination of hardware (e.g. hardware processor and memory) and software (a virtual machine).

The first server 130 is operative to communicate to the server 100 data 140 informative of a main media content.

The main media content includes at least one of an audio content and a video content.

According to some embodiments, the main media content can include a media content to be delivered using an over-the-top (OTT) media service (delivered directly to users over the Internet through streaming video services or devices).

The main media content includes for example a TV program, a video of a concert, a football game, a lecture, a radio content, a podcast, etc., which is to be watched and/or listened to on a user's device using a media player. The main media content can correspond to a streaming media. In some embodiments, this can correspond to live (or quasi live) streaming. This is, however, not limitative.

In some embodiments, data 140 informative of the main media content can include e.g. the main media content itself (which can be divided into a sequence of portions, also called chunks, each portion comprising a fraction of the main media content).

In some embodiments, data 140 informative of the main media content can include a reference (e.g. a link such as an Internet link) pointing to the main media content. Opening of the link enables to obtain (e.g. download) or play the main media content.

In some embodiments, data 140 includes an ordered sequence of references (e.g. links such as Internet links). Each link points to a fraction of the main media content, which can be stored remotely at a server. Opening of each link enables to obtain (e.g. download) or play a corresponding fraction of the main media content.

In some embodiments, data 140 corresponds to a manifest file (also called OTT manifest file) containing references to each file in a collection of files that are parts of the same audio and/or video asset defining the main media content.

According to some embodiments, server 100 is operative to communicate with a second server 141 (using wire and/or wireless communication). In some embodiments, the first server 130 and the second server 141 are part of the same server, or are distinct servers.

The second server 141 comprises a processor and memory circuitry 145. In some embodiments, the second server 141 can include virtual processing resources, such as at least one virtual machine (VM), or a combination of hardware (e.g. hardware processor and memory) and software (a virtual machine).

Server 100 is operative to receive data 148 informative of a media content from the second server 141. Data 148 informative of the media content can be stored e.g. in a memory 146 of the second server 141.

Data 148 informative of the media content can include e.g. the media content itself, and/or a reference pointing to the media content (e.g. a link such as an Internet link).

In a non-limitative example, the second server 141 can be e.g. an ad server, and the media content is an ad content (e.g. an advertisement including video and/or audio content). Although various examples are provided hereinafter with reference to ad content, it is to be understood that this is not limitative and that the media content can include other media contents of interest (e.g. audio content and/or visual content and/or video content which does not necessary correspond to an ad content).

In addition to the data 148 informative of the media content, server 100 is operative to obtain enrichment data 147 informative of a given enrichment content associated with the media content. As explained hereinafter, it is desired that the media content (or data informative thereof) and the given enrichment content (or data informative thereof) are executed at a user's device by a media player of the user's device (note that execution of the given enrichment content and execution of the media content can be performed in at least one overlapping period of time, but this is not mandatory).

According to some embodiments, at least part of the enrichment data 147 is obtained by server 100 from the second server 141, together with the media content itself (received as data 148 from the second server 141).

In some embodiments, server 100 already stores at least part of the enrichment data 147, for example in a memory of server 100.

In some embodiments, the enrichment content enables obtaining information on the user's behavior, e.g. during playing of the audio and/or video content of the media content (or of a main media content in which the media content has been inserted, as explained hereinafter). This information is of interest e.g. to understand the effect of the media content on the user (or the effect of a main media content in which the media content has been inserted, as explained hereinafter).

In some embodiments, the enrichment content enriches the user's experience during playing of the audio and/or video content of the media content (or during playing of a main media content in which the media content has been inserted, as explained hereinafter).

In some embodiments, the enrichment content enables performing an interaction with the user. This interaction can include e.g. enabling the user to click on an Internet link, and/or enabling the user to transmit text and/or audio and/or video content, and/or enabling a written and/or oral and/or video interaction with the user (e.g. a chat is opened with the user), and/or performing a survey, etc.

Various examples of the enrichment content will be provided hereinafter.

In some embodiments, the enrichment data 147 can correspond to the enrichment content itself. For example, the enrichment data 147 comprises a list of instructions stored in a file, such as an XML file. In some embodiments, both the enrichment data 147 and the data 148 informative of the media content are stored within the same file, such as a XMIL file.

In some embodiments, the enrichment data 147 includes a reference to the enrichment content. For example, the enrichment data 147 comprises identification data of a company or of a server, and server 100 automatically identifies the relevant enrichment content which is associated with this company or server. Examples will be provided hereinafter.

As visible in FIG. 1, server 100 can communicate with one or more user devices (see user devices 150₁ to 150_{N}), through e.g. wire and/or wireless communication (e.g. the Internet).

User devices can include (this list is not limitative) e.g. a computer, a cellular mobile (e.g. smartphone), a TV (e.g. smart TV), a tablet, a set-top box, a server, etc.

Each user device 150ᵢ (with i from 1 to N) includes a processor and memory circuitry 151₁, which is operative to execute a media player 160ᵢ (a computer-implemented media player).

A media player is a type of application software operative to play media content such as audio and/or video files.

According to some embodiments, at least some of the different media players among the various user devices are of different types. This can include the fact that the media players are different but operate on the same operating system and/or that the media players are different and also operate on different operating systems and/or the fact that the media players are different because they operate on different types of user devices (e.g. one operates on a smart TV, and another on a computer).

Examples of types of media players include e.g. (this list is not limitative): Roku player, JW player, HLSJS, VideoJS, Samsung TV, VLC, TheOPlayer, RadiantPlayer (this media player can be operated on different operating systems), EXOPlayer (operable on Android), etc.

Server 100 is operative to generate, based on the media content 148 and the enrichment data 147, augmented data 121ᵢ (with i from 1 to N).

The augmented data (121₁ to 121_{N}) can be respectively transmitted to one or more of the user devices 150₁ to 150_{N}.

A non-limitative embodiment of the augmented data 121ᵢ is depicted in FIG. 1A.

The augmented data 121ᵢ comprises data 156ᵢ informative of the media content. As explained beforehand, in some embodiments, server 100 obtains data 148 informative of a media content, e.g. from the first server 130. Server 100 can generate, based on data 148, data 156ᵢ informative of the media content. Indeed, as explained hereinafter, server 100 can perform various manipulations of the media content (such as, but not limited to, transcoding). Data 156ᵢ can correspond to the media content after this manipulation. In some embodiments, if the media content does not require any manipulation, then data 156ᵢ and data 140 can be the same.

Data 156ᵢ is denoted with an index “I” to indicate the fact that the media content which is transmitted (after manipulation) to a user's device 121ᵢ can be different from a media content which is transmitted (after manipulation) to another user user's device 121j (with j being different from i), since different types of user devices and/or different types of media players may require different formats of the media content. This is, however, not mandatory. In some embodiments, the media content can be different for different users' devices. For example, a personalized ad content is transmitted for each user, which is different among a plurality of users.

In addition to data 156ᵢ informative of the media content, the augmented data 121ᵢ includes a software module 155ᵢ. According to some embodiments, the software module 155ᵢ includes a list of instructions (e.g. an executable code/executable program/executable plug-in) stored in a memory. In a non-limitative example, the software module 155ᵢ is a JSON file. Execution of at least part of the software module 155ᵢ by a media player 160ᵢ of a user's device 150ᵢ enables execution of the given enrichment content associated with the enrichment data 147 at the user's device 150ᵢ.

Assume that the augmented data 121ᵢ is to be transmitted to a user's device 150ᵢ which implements a media player 160ᵢ of a given type (see above different non-limitative examples of media player types). As explained hereinafter, the software module 155ᵢ is intentionally selected to be executable by a media player of this given type (therefore it is noted with an index “I” to indicate that it is compatible with the media player 160). In other words, the software module 155ᵢ is compatible with this given media player type. Therefore, upon reception of the augmented data 121ᵢ by the user's device, the media player 160ᵢ of this user's device will be able to play the media content and to execute at least part of the software module 155ᵢ (since the software module 155ᵢ is executable by this media player 160). As mentioned above, execution of the software module 155ᵢ enables execution of the given enrichment content by the media player 160ᵢ. In some embodiments, the software module 155ᵢ includes (or is associated with) a timestamp indicative of a time period in which the software module 155ᵢ is to be executed by the media player of the user's device.

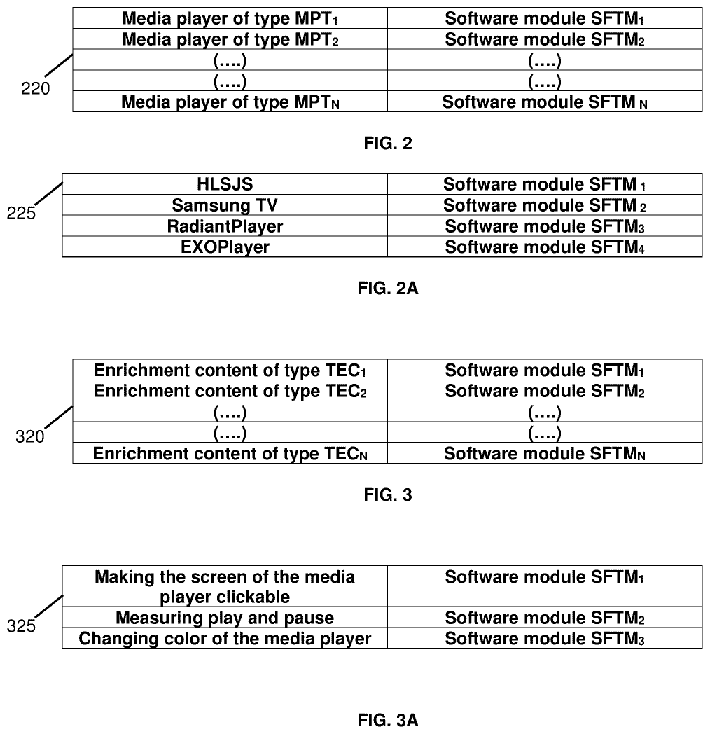

Attention is now drawn to FIG. 2.

Database 220 is a non-limitative example of database 120 mentioned in FIG. 1. Although database 220 is depicted as a table, this is not limitative, and data stored in the database 220 can be stored using any other adapted format or data structure.

Database 220 stores, for each of a plurality of different media player types MPTi (with i from 1 to N-MPT₁ corresponds to a first type of media player, and MPT_{N} corresponds to a N-th type of media player), a corresponding software module SFTMᵢ (with i from 1 to N). The software modules SFTMᵢ are generally different for each value of i.

In this database 220, software module SFTMᵢ is executable by media player of type MPTi. However, SFTMᵢ cannot be executed by at least some of the other media player types MPTj, with j different from i. This is due to the fact that media players of different types generally use/understand different sets of instructions and/or different programming languages and/or different formats of files, etc.

In other words, software module SFTMᵢ is specifically designed to be compatible with media player type MPTᵢ. This can be performed by intentionally selecting functions and/or a syntax and/or variables in the executable code of software module SFTMᵢ which are readable and executable by a media player of type MPTᵢ.

FIG. 2A illustrates a non-limitative example 225 of the database 220 of FIG. 2.

Database 225 stores:
software module STFM₁ executable by media player “HLSJS”;
software module STFM₂ executable by media player “Samsung TV”;
software module STFM₃ executable by media player “RadiantPlayer”; and
software module STFM₄ executable by media player “EXOPlayer”.

It may occur that two different media players, operative on the same operating system, require two different software modules.

It may also occur that two different media players can execute the same software module (because although they are different media players, they share some commonalities). In this case, a single software module can be stored in the database for the two different media players.

Attention is now drawn to FIG. 3.

FIG. 3 depicts a database 320. Database 320 is a non-limitative example of database 120 mentioned in FIG. 1. Although database 320 is depicted as a table, this is not limitative, and data stored in the database 320 can be stored using any other adapted format or data structure.

It has been mentioned with reference to FIG. 1 that server 100 receives enrichment data 147 informative of an enrichment content.

Enrichment content can be classified into different types of enrichment content. Types of enrichment content include e.g. (this list is not limitative):
Tracking of behavior of the user (this tracking can be performed over time), such as:
   Measurement of pause and play;
   Detection of mute/unmute (this detects whether the user selects mute/unmute in the media player);
   Detection of fullscreen (this detects whether the user selects or exits a fullscreen mode in the media player);
   Detection of skip (this detects whether the user skips content);
   Etc.
Enabling an interaction with the user. This can include for example:
   Making the screen of the media player clickable to enable an interaction (such as opening a link);
   Tracking position of the mouse of the user (and in some cases, triggering an action depending on the position of the mouse);
   Enabling a chat with the user;
   Changing visual aspect of the media player (e.g. color of the media player, adding a banner to the media player, etc.);
   Performing a survey/asking questions to the user;
   Etc.

The types of enrichment content listed above are only examples and are not limitative. As explained hereinafter, other types of enrichment content can be used, enabling other types of interactions with the user and/or monitoring of the user's behavior. In some embodiments, the type of enrichment content does not fall into any of the types defined above, and can be any desired interaction and/or technical effect and/or creative effect produced by executing an executable code by the media player.

According to some embodiments, the enrichment content depends on time. For example, it requires executing an action only at a predetermined period of time (this period of time can be defined e.g. relative to the media content, and/or relative to a main media content in which the media content is inserted).

According to some embodiments, at least some of the enrichment content obtained by server 100 is expressed according to the standard VAST (Video Ad Serving Template).

According to some embodiments, at least some of the enrichment content obtained by server 100 is expressed according to the standard VPAID (Video Player-Ad Interface Definition).

This is, however, not limitative, and in some embodiments the enrichment content neither complies with the VAST standard, nor with the VPAID standard.

Assume that the database 320 is devoted to a given type of media player (that is to say that any software module stored in the database 320 should be executable/readable by this given type of media player).

Database 320 stores, for each given type of a plurality of different types TECᵢ of enrichment content (TEC stands for ‘Type of Enrichment Content’, with i from 1 to N-TEC₁ corresponds to a first type of enrichment content, and TEC_{N} corresponds to a N-th type of media player), a corresponding software module SFTMᵢ (with i from 1 to N), which enables a media player of the given media player type to execute an enrichment content of the given type TECᵢ. Non-limitative examples of different types of enrichment content have been provided above.

The software modules SFTMᵢ are generally different for each value of i since they enable execution of different types of enrichment content.

FIG. 3A illustrates a non-limitative example 325 of the database 320 of FIG. 3. Assume that the database 325 is devoted to a media player of type “RadiantPlayer”. In this non-limitative example, database 355 stores:
software module STFM₁ executable by media player “RadiantPlayer”, to make the screen of the media player clickable;
software module STFM₂ executable by media player “RadiantPlayer”, to measure play and pause by the user during execution of the media content;
software module STFM₃ executable by media player “RadiantPlayer”, to change color of the media player at the user's device.

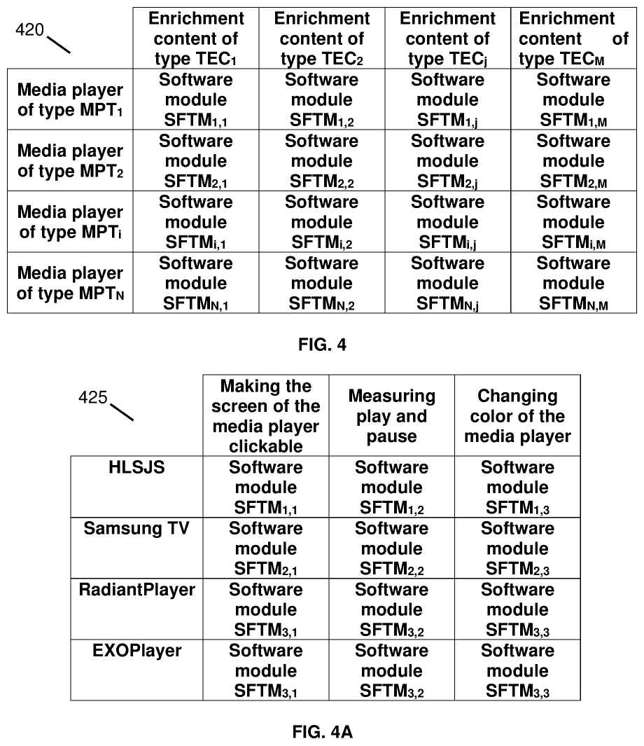

Attention is now drawn to FIG. 4.

FIG. 4 depicts a database 420. Database 420 is a non-limitative example of database 120 mentioned in FIG. 1. Although database 420 is depicted as a table, this is not limitative, and data stored in the database 420 can be stored using any other adapted format or data structure.

Database 420 stores, for each of a plurality of different media player types MPTi (with i from 1 to N-MPT₁ corresponds to a first type of media player, and MPT_{N} corresponds to a N-th type of media player) and for each given type of a plurality of different types TECⱼ of enrichment content, (TEC stands for ‘Type of Enrichment Content’, with j from 1 to M-TEC₁ corresponds to a first type of enrichment content, and TEC_{M} corresponds to a M-th type of enrichment content), a given software module SFTM_{i,j} enabling a media player of the given media player type MPTi to execute an enrichment content of the given type TECⱼ.

In other words, each software module of the database 420 enables execution of a given type of enrichment content by a given type of media player.

FIG. 4A illustrates a non-limitative example 425 of the database 420 of FIG. 4.

As visible in FIG. 4A, for each type of media player, and each type of enrichment content, a dedicated software module is stored within the database 425. For example, software module SFTM_{3,3} enables changing color of a media player of type “RadiantPlayer”, when this media player executes the executable code of SFTM_{3,3}.

The database 425 can include different types of media players and/or different types of enrichment content than those depicted in FIG. 4.

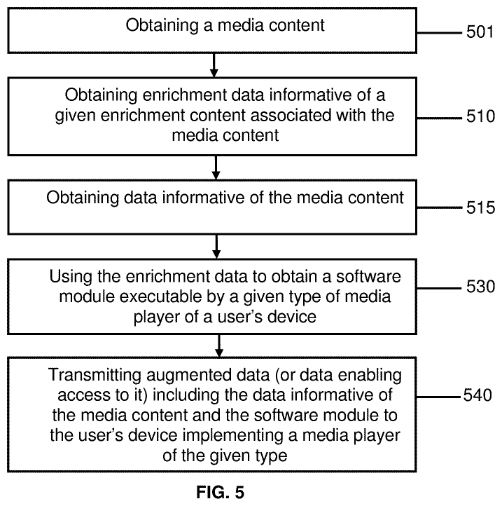

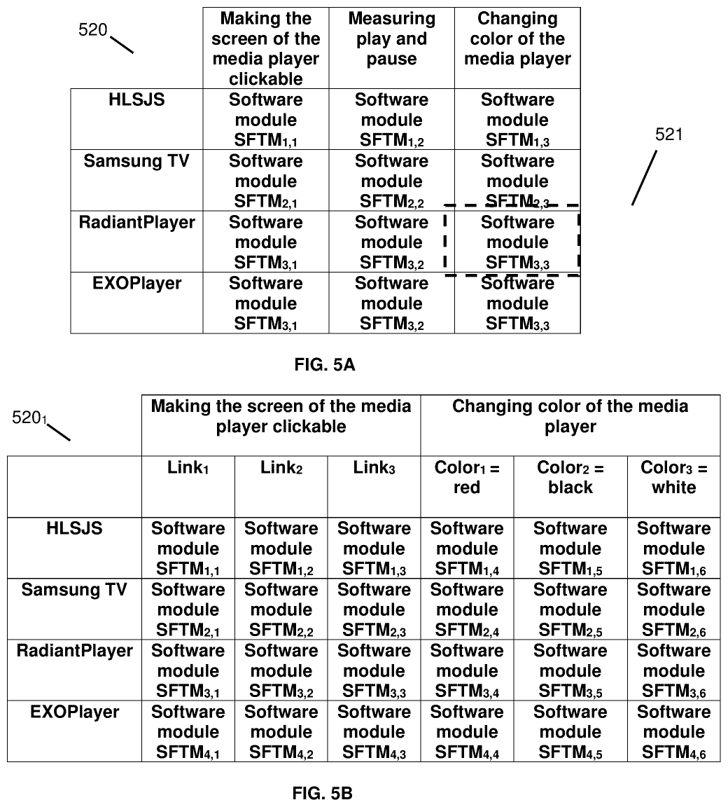

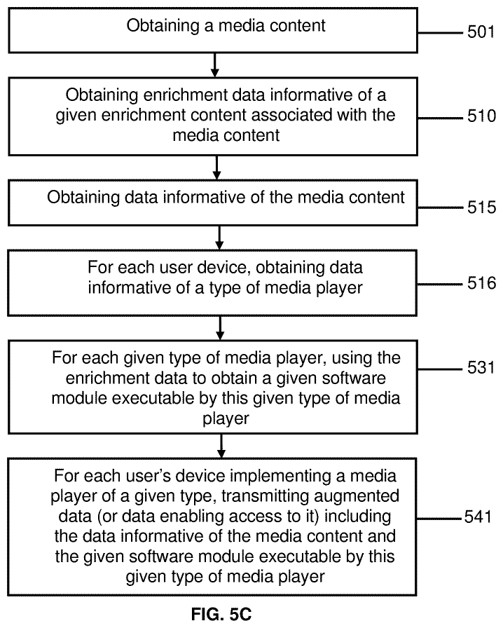

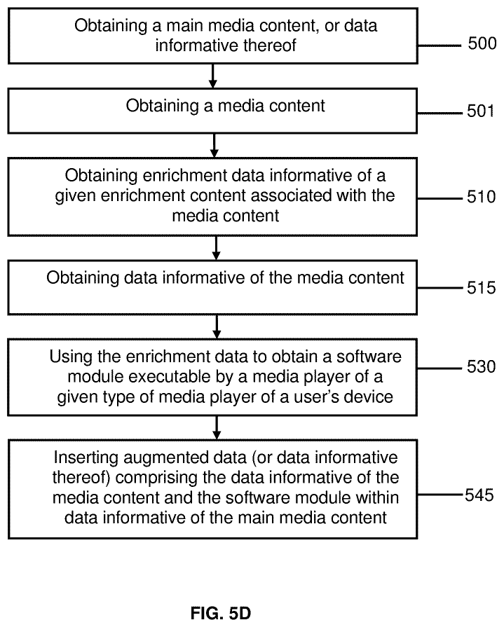

Attention is now drawn to FIG. 5 which depicts a method of generating augmented data (see e.g. augmented data 121ᵢ in FIG. 1A). This method can be performed at least partially by server 100.

The method includes obtaining (operation 501), by server 100, a media content comprising at least one of an audio content and a video content. In some embodiments, server 100 receives the media content from the second server 141, and/or a link enabling access to the media content.

The method includes obtaining (operation 510), by server 100, enrichment data (see reference 147 in FIG. 1) informative of a given enrichment content associated with the media content (e.g. the enrichment content is to be executed with the media content).

For example, server 200 receives an advertisement content (media content), together with an information (enrichment data) that the advertisement should be made clickable to enable access to a given website by a user watching the advertisement.

Although the effect produced by the given enrichment content can be produced at the same time as playing of the media content, this is not necessarily the case. For example, the enrichment content can define that when the media content is finished, the effect of the enrichment content should be performed. In some embodiments, the effect produced by the enrichment content can last more than the duration of the media content. For example, the effect produced by the enrichment content corresponds to displaying a banner on the screen of the user even after playing of the media content by the media player has ended.

In some embodiments, the method includes determining a type of the given enrichment content.

In some embodiments, the enrichment content is received as a list of instructions formulated according to the VAST format. VAST uses standardized and predefined types of functions, which are apriori known. Therefore, the type of each given enrichment content can be detected by detecting these predefined functions.

For example, if it is desired to measure pause and play in the media content, VAST requires use of the following function:

```
<Tracking event=“pause”>
  Internet link to report
    </Tracking>
```

The Internet link to report is an Internet address indicating to whom the monitoring of the tracking event should be reported.

This holds true for all other functions of VAST (such as <Tracking event=“mute”> which tracks when the user selects mute and is associated with an Internet link for reporting the monitoring of the tracking, <Tracking event=“fullscreen”>, which tracks when the user selects the fullscreen mode and is associated with an Internet link for reporting the monitoring of the tracking). Therefore, when the server 100 receives the enrichment content encoded according to the VAST standard, it can perform a textual analysis (also called “parsing”) of the list of instructions of the enrichment content, to detect these predefined functions (since their syntax is known in advance). For example, the enrichment data 147 is in an XMIL file which can be parsed to detect these VAST functions.

If, for example, the expression <Tracking event=“pause”> is detected, server 100 determines that the enrichment content comprises an instruction to measure pause and play, and also extracts the Internet link to whom the monitoring of the tracking should be reported.

The same holds true for all standardized functions which can be detected by server 100 based on a textual analysis (parsing) of the list of instructions of the enrichment content.

In some embodiments, the enrichment content is received as a list of instructions formulated according to the VPAID format. The server 100 is able to detect the presence of a VPAID code within the enrichment content. This can be detected by parsing the list of instructions of the enrichment content, and by detecting tags such as “VPAID” and/or “type=“application/javascript” ”, or similar tags which indicates that a VPAID code is present (other methods can be used). A non-limitative example is provided below:

```
<MediaFile apiFramework=“VPAID” type=“application/javascript”>
  Internet link of the application
    </MediaFile>
```

In this non limitative example, the tag <MediaFile apiFramework=“VPAID” type=“application/javascript”> indicates that a VPAID code should be executed. The XML file also includes an Internet link which stores the JavaScript code of the application to be executed. Server 100 is able to detect the tag and to extract the Internet link, enabling access to the application to be executed. In some embodiments, the XML file includes the code itself which can be also extracted by server 100.

In some embodiments, server 100 receives enrichment data 147 which comprises a reference to the given enrichment content.

In some embodiments, this reference is a link which enables server 100 to access (e.g. download) the enrichment content.

In some embodiments, this reference indicates to the server 100 the nature of the enrichment content.

It can be predefined in advance that if server 100 receives a media content 148 (e.g. an ad content) of a given company and/or of a given type, this implies that a given enrichment content should be associated with this media content 148. The server 100 can store, e.g. in a memory, predefined rules which indicate for each given company, and/or for each type of ad, and/or for each ad server (or other parameters to be defined), which enrichment content is to be associated with the media content 148. In this case, the second server 141 is not required to provide the enrichment content itself to server 100, since server 100 can deduce, based on predefined rules, which enrichment content is to be associated with the media content 148.

For example, a predefined rule defines that for a given company for which the ad content is produced, a modification of the color of the media player, according to the color of the given company's logo, is required.

Enrichment data 147 can include, in this case, the name of the company, which is detected by server 100 and automatically understands (based on the predefined rules stored in a memory) that the enrichment content associated with the ad content corresponds to a modification of the color of the media player according to the color of this company's logo.

In another example, when server 100 receives a media content from a given second server 141, a predefined rule defines which enrichment content should be associated with this media content (for example, it has been agreed that any ad content transmitted by this given second server 141 should be associated with a clickable content). In this case, enrichment data 147 can correspond to the address (or other identification number) of this given second server 141.

These examples are not limitative.

To summarize, the enrichment data 147 can include the enrichment content itself, and/or a reference enabling server 100 to select the relevant enrichment content.

In some embodiments, the method further includes (515) obtaining (by server 100) data informative of the media content.

In some embodiments, operation 515 can include modifying the media content (e.g. ad content) received from the second server 141. Modifying the media content can include transcoding the media content. Transcoding includes changing the format of the media content, which comprises changing at least one of a codec, a resolution, a quality, a protocol (etc.) of the media content. This can be required to adapt the media content to the type of user's device or to the type of media player of the user's device (e.g. a smart TV does not require the same format as a tablet or a small mobile device).

In some embodiments, operation 515 can include diving the media content into a plurality of fractions of the media content (also called chunks), and transcoding each fraction of the media content.

As explained hereinafter, in some embodiments, the media content which is received by server 100 is inserted (stitched) within a main media content (see reference 140 in FIG. 1), and transcoding ensures that each piece of media content has the same format as the main media content.

In some embodiments, transcoding is performed by another server, and/or has been already performed. In this case, data informative of the media content obtained at operation 515 can correspond to the media content itself as received by server 100 from the second server 141.

Assume that the media content (e.g. ad content), together with the given enrichment content, is to be transmitted to a user's device which implements a media player of a given media player type (see above various examples of media player types).

The type of the media player of a user's device can be detected using various methods.

In some embodiments, the media content is to be inserted (stitched) within a main media content. The main media content is played by the media player using e.g. a manifest (list of links to pieces of the media content). The manifest which is transmitted to the user has a different address, depending on the type of media player of the user. For example, the manifest transmitted to a smart TV has a different address than the manifest transmitted to a small mobile device. This address is generated e.g. by a server which knows in advance the type of device or type of media player of the users. Based on the address stored in the manifest transmitted to each user, the type of media player of each user device can be deduced.

In some embodiments, the type of media player can be determined based on requests transmitted by each user's device. When a user's device requests a content from server 100, it transmits requests for example with its user-agent (Chrome, Edge, etc.). Server 100 can automatically detect based on these requests the user agent. In some embodiments, the user agent indicates the type of media player (for example, Android can indicate that the media player is EXOPlayer, which is the native media player of Android-in some cases, if the user of Android uses a different media player, this can be detected based on requests of its user agent).

In some embodiments, the type of media player is provided e.g. by a third party (e.g. another server indicates to which type of media player the media content and the enrichment content is to be sent).

In some embodiments, a link of the manifest includes a string which is specific to each type of media player, thereby enabling detection of the type of media player (for example, http://media.net?player=HLSJS indicates that the user's device runs the media player HLSJS).

The method further includes (operation 530) using the enrichment data 147 to obtain a software module executable by a media player of the given media player type, wherein execution of at least part of the software module by the media player enables execution of the given enrichment content by the media player. The given enrichment content is not necessarily executed during playing of the media content and can be executed once the media content has been played and/or during a predetermined period of time.

Operation 530 can include extracting a first software module from a database (such as e.g. database 420—this is, however, not limitative, and other databases can be used). The first software module is selected in the database 420 such as it is executable by/adapted to a media player of the given media player type. In addition, the first software module is selected as it enables execution of the given enrichment content.

As explained hereinafter, in some embodiments, the software module corresponds to the first software module, and in other embodiments, the software module is generated using the first software module and the enrichment data.

According to some embodiments, each software module can be stored in the database (e.g. database 420) as a “template”. The template includes an executable code with variables whose values need to be defined depending on the enrichment content.

For example, if a VAST function has been identified as part of the enrichment content with a given Internet link (www.address-to-report.com) to report behavior of the user, a corresponding template corresponding to this VAST function is extracted from the database which is executable by a media player of the type of the user. The template includes a variable corresponding to the Internet link to report, which is updated and set equal to the given Internet link www.address-to-report.com.

Another example is described hereinafter with reference to FIG. 5A. The software module which enables changing color of the media player, comprises an executable code enabling changing color of the media player, with a variable “color” whose value is to be defined.

Assume that server 100 receives enrichment data 147 which corresponds to an enrichment content “changing the color of the media player to”, for a media player of type “RadiantPlayer”.

Therefore, server 100 can extract from the database the relevant software module enabling changing color of the media player, and defines that within the software module, the value of the variable “color” is equal to red. In other words, a template is extracted from the database which is then completed/updated using the enrichment data 147. In some embodiments, the code of the software module is a code which refers to a variable color (e.g. “variable color”), and the variable color is set equal to red (“variable color=red”−the software module can therefore comprise an executable portion which does not need to be modified and a modifiable portion defining values of the variables used by the executable portion).

In database 520 of FIG. 5A, the first software module SFTM_{3,3}(see reference 521) is extracted, since it enables changing of a color of the media player for RadiantPlayer. Since the enrichment data 147 indicates that the color is equal to “red”, the software module is generated by defining, within the first software module SFTM_{3,3}, the color to be equal to “red”.

In other embodiments, for each type of enrichment content executable by a given type of media player, the database stores different software modules for each possible values of the variable(s) of the software module. In other words, the database does not store templates, but software modules ready to be used.

In this case, at operation 530, the method comprises directly extracting the software module which is executable by a media player of the given media player and which enables executing the given enrichment content. It is not necessary to further update the extracted software module.

A non-limitative example is provided with reference to the database 520₁ of FIG. 5B. As visible in FIG. 5B, for the enrichment content “Changing color of the media player”, for each type of media player, a software module is stored in the database for each of a plurality of predefined colors. Therefore, it is possible to immediately extract the relevant software module from the database. In the example mentioned above in which the enrichment content requires modification of the color of a media player of type RadiantPlayer to red, software module SFTM_{3,4} will be extracted from the database 520₁ at operation 530.

This applies also for other types of enrichment content. For example, for the enrichment content “Making the screen of the media player clickable”, for each type of media player, a software module is stored for each of a plurality of predefined links to which the user should have access when clicking on the screen. Therefore, it is possible to immediately extract the relevant software module from the database.

In some embodiments, the enrichment content 147 includes a VPAID code including an Internet address www.vpaid-code-to-execute.com storing the executable code to be executed.

Assume that database 420 stores, for each given type of media players of a plurality of different types of media players, a software module enabling executing a VPAID code by this given type of media player. Each software module can be stored as a template in which the variable is e.g. an Internet link to be defined, and enabling access to the VPAID code (e.g. JavaScript code) to be executed.

Operation 530 can include extracting from the database (e.g. database 420) a first software module which enables executing a VPAID code by a media player of the given type of media player of the user's device. This first software module can be updated by setting the variable “Internet link” equal to www.vpaid-code-to-execute.com present in the enrichment data 147, to obtain the software module which is required for the user.

In some embodiments, at operation 530, the software module can be extracted from a database 320/325 as illustrated in reference to FIGS. 3 and 3A.

Indeed, in some embodiments, the type of media player is fixed (for example, a publisher of ad content only transmits content to a given type of media player). In this case, the database does not need to store software modules for different types of media players. The database needs only to store software modules for different types of enrichment content. The method therefore comprises selecting the relevant software module enabling execution of the given enrichment content (with the relevant type).

In some embodiments, at operation 530, the software module can be extracted from a database 220/225 as illustrated in reference to FIGS. 2 and 2A.

Indeed, in some embodiments, the type of enrichment content is fixed (for example, a publisher of ad content is interested only in a given type of enrichment content, but the ad content should be transmitted to different types of media players). In this case, the database does not need to store software modules for different types of enrichment content. The database needs only to store software modules for different types of media players. The method therefore comprises selecting the relevant software module for the given type of media player, which enables execution of the given type of enrichment content.

In some embodiments, the enrichment content does not necessarily comply with standards such as VAST or VPAID.

In particular, it is possible to select any relevant enrichment content which can be described by an executable code (e.g. JavaScript code—this is not limitative).

Assume that a publisher of ad content would like to execute with the ad content a specific enrichment content (which is not formulated according to VAST or VPAID).

A predefined rule can set that this publisher requires specific enrichment content, known in advance.

Server 100 can communicate with a database which already stores a software module enabling execution of this specific enrichment content (e.g. as an executable code), for each of a plurality of media player types. Therefore, operation 530 can include selecting the software module which enables execution of this specific enrichment content for the given media player type of the user's device.

In some embodiments, new standardized functions defining enrichment content are defined. These new standardized functions can be part of a definition of an extension of the standard VAST. For example, a new standardized function is “opening a chat with the user”, or “sending a message to the telephone of the user”. When a third party (such as the second server 141) would like to trigger one of these functions, it should transmit an XML file (enrichment data 147) storing the relevant standardized function according to the extension of the VAST standard. A database (such as database 420) is prepared in advance to store, for each new standardized function defining a given type of enrichment content, and for each type of media player, a corresponding software module enabling execution of the given type of enrichment content.

A non-limitative example of an enrichment content which is not supported by VPAID is provided hereinafter.

Some media players are not tied to a browser (such as Roku player). In order to enable a user of Roku player to access a desired Internet link (e.g. Internet link of the company for which the ad content is streamed at the user's device), a software module can be prepared (and stored e.g. in a database of server 100) for Roku player which enables the user to click on a predefined portion of the screen (e.g. “Please click here to access the website of the company”), and which, upon detection of this click by the user, triggers transmission of a SMS to the mobile phone of the user, wherein the SMS comprises an Internet link enabling access to the desired Internet link. This kind of interactive content is not supported by VPAID, since VPAID is a generic language which is not dependent on the type of media player.

Server 100 detects (e.g. by parsing) at least one of these new standardized functions in the XML file (enrichment data 147) and extracts from a database the corresponding software module executable by a media player of the given type of media player of the user's device. If the new standardized function includes a variable to be defined (e.g. duration of the chat with the user), server 100 can define the value of the variable based on the enrichment data 147 (which includes the value of the parameters of the new standardized function).

In some embodiments, the enrichment content comprises a plurality of enrichment contents (which need to be executed simultaneously, or at different periods of time), which are of different types. In this case, operation 530 can include extracting a plurality of software modules, one per type of enrichment content (each software module being selected to be executable by the type of media player of the user to which the data is to be transmitted).

For example, the publisher of the ad content would like to both modify the color of the media player and to make the screen of the user clickable, in a media player of type “RadiantPlayer”. In this example, software module SFTM_{3,1} and software module SFTM_{3,3} are extracted from database 520.

Following operation 515 and 530, augmented data is obtained, which includes data informative of the media content (as obtained at operation 515) and the software module (as obtained at operation 530). The augmented data is executable (compatible) with the media player of the user's device.

If the media content (ad content) and the enrichment content is to be executed by different media players of different types, augmented data specific to each media player can be generated (see reference 121ᵢ in FIG. 1A). In particular, the augmented data to be transmitted to each user includes a software module (obtained at operation 530) which is selected to be executable by the media player of this user. Concerning the data informative of the media content (as obtained at operation 515), it can be the same among media players of different types, or can be different (for example, if the format supported by each media player is different, transcoding will generate different data informative of the media content, specifically adapted to the user's device/media player).

The method further comprises transmitting (operation 540) the augmented data, to the user's device (or to the user's devices). In some embodiments, server 100 stores the augmented data (e.g. in a memory) and transmits to each user's device data enabling access to the augmented data relevant for this user's device (such as a link).

In other words, second server 141 provides a media content and a given enrichment content to be transmitted to various users, and server 100 ensures that each given user's device receives augmented data informative of this media content together with a software module enabling execution of the given enrichment content by the media player of this given user's device.

FIG. 5C illustrates the method of FIG. 5 which can be applied for a plurality of user devices.

Assume that second server 141 would like to stream an ad content with an enrichment content to a plurality of user devices. Among at least some of the user devices, media players of different types are used.

The method of FIG. 5C includes operations 501, 510 and 515 as described above. For each user device, the method includes obtaining (operation 516) information on a type of the media player.

For each given type of media player (as identified at operation 516), the method includes (operation 531) using the enrichment data to obtain a given software module executable by this given type of media player.

For each given type of media player, augmented data is therefore obtained which includes data informative of the media content (as obtained at operation 515) and the given software module (as obtained at operation 531). Each user receives augmented data in which the given software module is executable by the media player implemented on the user's device (operation 541). In some embodiments, the second server 141 transmits an ad content to server 100 and indicates that the enrichment content which should be executed with the ad content depends on the type of media player. For example, second server 141 indicates that an enrichment content of different type is to be executed for each type of media player (e.g. RadiantPlayer should receive an ad content which is clickable and HLSJS should receive an ad content enabling a chat). In this case, server 100 can extract in the database a software module enabling execution of a different enrichment content depending on the type of media player to which the ad content is to be transmitted, in compliance with the requirements of the second server 141.

In a variant of the method of FIG. 5, which is illustrated in FIG. 5D, the method comprises obtaining (operation 500) data (see e.g. reference 140 in FIG. 1) informative of a main media content to be streamed at the user's device.

In some embodiments, data 140 informative of the main media content includes a list of links (also called manifest) enabling access to an ordered sequence of pieces of media content to be played by the media player of the user. For example, the main media content is a TV program.

Server 100 is operative to stich, within the main content, additional content of interest, such as (but not limited to) interactive ad content.

The method further includes operations 501, 510, 515, 530 as described above. As explained above, augmented data is obtained, including data informative of the media content, playable by the media player of the user's device, and a software module executable by the media player of the user's device, wherein execution of at least part of the software module by the media player enables execution of the given enrichment content by the media player.

The method includes inserting (545) within the data informative of the main media content (e.g. manifest), data informative of the augmented data (e.g. a new chunk including a link to the augmented data), to obtain updated data. The updated data is then transmitted to the user's device (or to each user's device).

Operation 545 can include inserting (this operation is also called “stitching”), within the list (manifest), a new link enabling the user's device to access the augmented data. An updated manifest is therefore obtained, which is transmitted to the user's device.

In some embodiments, the augmented data is split into a plurality of chunks. Therefore, operation 545 includes inserting within the list a plurality of links, each enabling access to a chunk of the plurality of chunks of the augmented data.

In some embodiments, insertion of the augmented data within the data informative of the main media content (manifest) can be performed in real time, or quasi real time. In particular, in some embodiments, the main media content is continuously delivered (streamed) to the user's device and server 100 dynamically stitches the augmented data within the stream, without delaying transmission of the main media content.

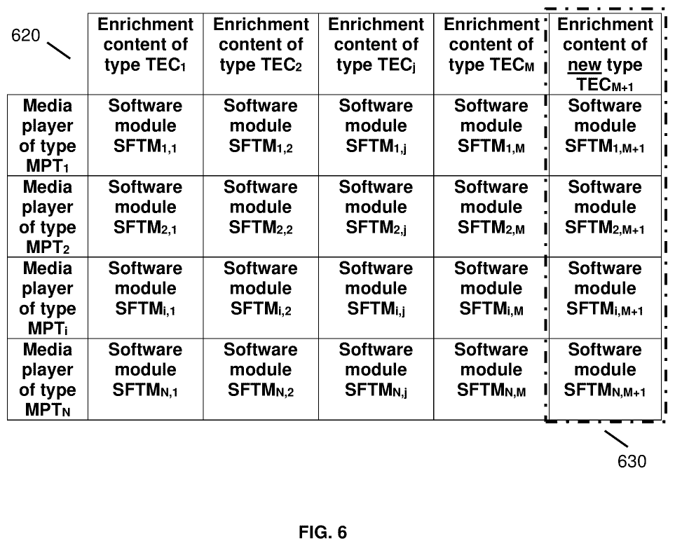

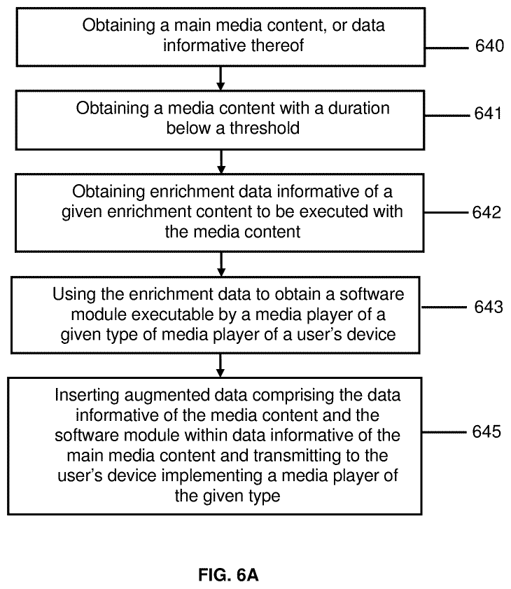

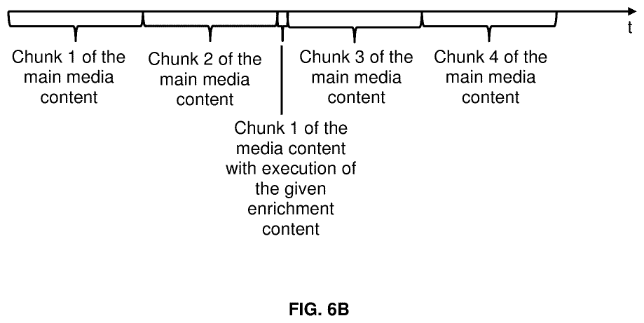

Attention is drawn to FIG. 6.

Assume that a publisher (second server 141) is interested in executing a new enrichment content in its ad content. In some embodiments, the new enrichment content is not supported by standards such as VAST or VPAID.

According to some embodiments, it is possible to ensure execution of this new enrichment content and compatibility with various types of media players in a flexible way.

Indeed, it is possible to update the database (see database 620) which stores the various software modules for the different types of media players and/or different types of enrichment content. This is shown in FIG. 6, in which a new column 630 (this representation is not limitative, and other data structures can be used) of the database 620 is added for supporting the new enrichment content (referred to as enrichment content of type TEC_{M+}1). This new column stores, for each given type of media players of a plurality of different types of media players, a software module enabling execution of the new enrichment content by a media player of the given type.

Assume that an ad content is associated with the enrichment content of the new type (type TEC_{M+1}), for a user using a media player of a given type. It is possible to extract the software module from column 630 of database 620 which is adapted to this given type of media player, and to transmit the software module to the user's device, together with the ad content, as explained with reference to FIGS. 5 and 5C.

Attention is drawn to FIG. 6A.

The method of FIG. 6A includes obtaining (operation 640) data informative of a main media content to be streamed at the user's device.

In some embodiments, data informative of the main media content includes a list of links (also called manifest) enabling access to an ordered sequence of pieces of media content to be played by the media player of the user.

In some embodiments, it is desired to enrich the main media content with an enrichment content (e.g. monitoring behavior of the user, performing an interaction with the user, etc. -see the various examples above).

The method can include obtaining (operation 641) a media content comprising at least one of an audio content and a video content, wherein a duration of the media content is below a predefined threshold. For example, the predefined threshold is such that, if the media content is inserted within the main media content, the human eye and/or ear cannot notice presence of the media content. In some embodiments, the predefined threshold is equal to 1 or 2 ms. This is not limitative. According to some embodiments, the audio content of this media content corresponds to a silence (no audio content), and the video content of this media content corresponds to a black screen. This is, however, not limitative.

The method further includes obtaining (operation 642) enrichment data informative of a given enrichment content associated with the media content. In this embodiment, the media content is used in fact as a “vehicle” to enable execution of the given enrichment content during playing of the main media content.

For example, assume that the main media content is a lecture, and the enrichment content includes displaying questions to the user during the lecture. This is, however, not limitative.

Assume that the media player of the user who watches the main media content is of a given type.

The method includes using (operation 643) the enrichment data to obtain a software module which meets two conditions:
the software module is executable by a media player of this given type;
the software module enables executing the given enrichment content by the media player.

As explained above with reference to FIG. 5 (see explanations relative to operation 530), the software module can be extracted from a database, or can be generated based on a first software module extracted from a database and the enrichment data. The same applies herein.

As a consequence, augmented data, including the media content (e.g. a short silence) and the software module, is obtained.

The method includes inserting (645) within the data informative of the main media content (e.g. the manifest), data informative of the augmented data (e.g. a link enabling access to the augmented data), to obtain updated data. The updated data is then transmitted to the user's device (or to each user's device).

The updated data can correspond to an updated manifest, which includes a new link to the augmented data.

As shown in FIG. 6B, when the media player of the user reaches the new link in the manifest, it plays the media content of short duration, and executes the software module. As a consequence, the enrichment content is executed at the user's device. Since the media content is of short duration, the user does not notice presence of this media content, and therefore executing of the main media content is not perturbated, while ensuring execution of the enrichment content.

Since the media content is of short duration, execution of the enrichment content can last even after the media content has ended.

For example, the media content is a short “silence” and the enrichment content is a survey in which questions are asked to the user about the lecture (corresponding to the main media content).

In some embodiments, the enrichment content has a predefined duration and lasts after this predefined duration.

In other embodiments, in order to disable execution of the enrichment content, after a period of time a new enrichment content is transmitted together with a media content of short duration, in which the new enrichment content includes an instruction to stop the execution of the enrichment content, which has been previously triggered.

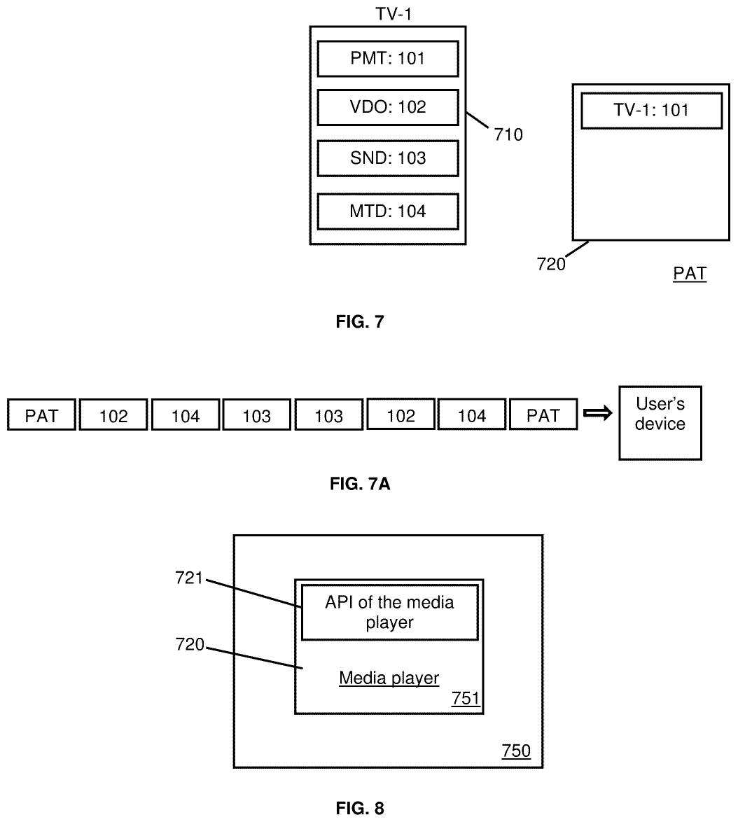

Attention is now drawn to FIG. 7.

According to some embodiments, the augmented data is transmitted using an MPEG transport stream (MPEG-TS, MTS). In particular, as explained hereinafter, a MPEG file including the augmented data can be created.

This is however not limitative and other format/transport streams can be used, such as, for example, MP4 in which the metadata is stored in an ID3 tag of a MP4 file.

Data informative of the media content (see 156ᵢ in FIG. 1A) can be transmitted using the audio and/or video channels of the MPEG transport stream, and the software module (see 155ᵢ in FIG. 1A) can be transmitted as metadata of the MPEG transport stream.

Program-specific information (PSI) of the MPEG transport stream can be used to transmit the augmented data.

This is illustrated in FIG. 7, in which a program 710 (TV-1) comprises a Program Mapping Table (PMT) with value 101. The PMT points to three channels (video channel 102, sound channel 103 and metadata channel 104. A PAT (Program Association Table) 720 lists all programs available in the transport stream. In the example of FIG. 7, the PAT points to the PMT table with value 101.

In the program 710, the video channel 102 and the sound channel 103 comprise the media content (e.g. ad content), after transcoding, to be transmitted to the user's device.

The metadata channel 104 comprises the software module as obtained at operation 530.

When the augmented data is transmitted (see FIG. 7A), the various pieces of data (video, sound, software module) are interlaced within the transport stream transmitted to the user's device. As explained hereinafter, the media player is able to identify the different channels of the transport stream using the PAT and the PMT.

Attention is now drawn to FIG. 8.

A media player 720 is operable by a processor and memory circuitry 751 at the user's device 750.

According to some embodiments, the media player 720 receives the augmented data transmitted by server 100. The media player 720 plays the media content of the augmented data and executes the software module of the augmented data, thereby enabling executing of the enrichment content, e.g. during playing of the media content.

According to some embodiments, the media player 720 comprises an API 721 (Application Programming Interface, for example JavaScript API). The API 721 enables implementing a computer-implemented function at the media player 720, such as a listener. According to some embodiments, the listener of the media player 720 is programmed to make the media player extract the metadata from the data stream, and to execute the metadata received within the data stream. In some embodiments, the listener of the media player 720 is programmed to execute the metadata received within the data stream at a period of time (“timestamp”) defined within the metadata.

A non-limitative example of a program which can be used to implement a listener at the media player is provided below (this program is not limitative—note that the program is different for different types of media players, since different types of media players have a different API). In this non-limitative example, the media player parses a JSON string received within the metadata and constructs an object (e.g. JavaScript object) described by the string.

amp.addEventListener(“timedmetadata”, runMetadata );
function runMetaData(event){
let metaData = JSON.parse(metaData.data);
metaData.exec( );
}

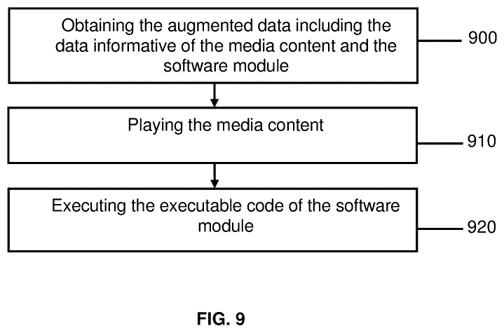

Attention is now drawn to FIG. 9, which depicts operations performed at the user's device.

Assume that the user's device implements a media player of a given media player type.

As explained with reference to FIGS. 5 and 5C, the user's device receives (operation 900) augmented data (or data enabling access to the augmented data, such as a link within a manifest). The augmented data includes a media content (e.g. an ad content) playable by the media player of the user's device, and a software module informative of a given enrichment content, wherein the software module comprises an executable code executable by the media player of the given media player type. In other words, the augmented data is compatible/executable by the media player of the given media player type.

The media player of the user plays the media content (operation 910). In addition, it executes (operation 920) at least part of the executable code of the software module.

Execution of the at least part of the executable code of the software module enables execution of the enrichment content.

As explained above, the software module is compatible with the given type of the media player of the user's device. The software module is not executable by at least some media players which are not of the given type, which is why server 100 selects (see operation 530) a software module specifically compatible with the given type of media player of the user's device.

In other words, although the media player was (before receiving the augmented data) in a mode in which it could only play the content received from a server (playing mode), upon receipt of the augmented data, it can now both play the media content and execute the enrichment content (the media player exited the mode in which it could only play a media content).

In some embodiments, if the augmented data is transmitted using the MPEG transport stream, the media player differentiates between the video channel, the sound channel, and the metadata channel, by using the PSI transmitted within the transport stream. Indeed, as explained with reference to FIG. 7, the PAT points to the PMT which lists all elementary streams present in the program (e.g. video channel, audio channel, and metadata channel). Therefore, the media player first identifies the PAT, then uses the PMT to determine to which channel belongs each received packet, and executes the corresponding action. For the video channel and audio channel, the media player plays the video content and audio content, and for the metadata channel the media player executes the content of the metadata which includes the software module transmitted by the server 100 in order to execute the enrichment content.

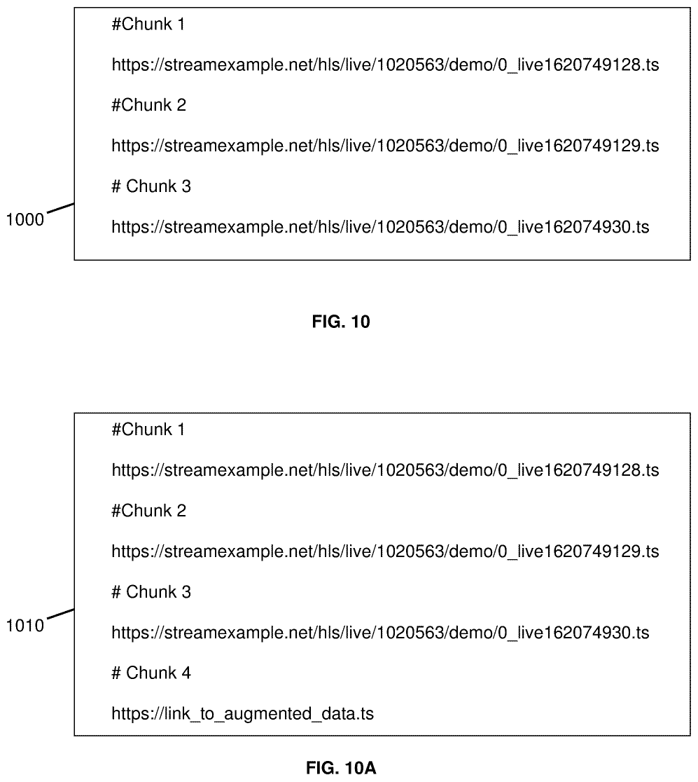

Attention is now drawn to FIG. 10, which describes a non-limitative example of the method of FIGS. 5 and 5C.

Assume a user's device requests a manifest 1000, which includes a list of links to a plurality of pieces (also called chunks) of a main media content to be streamed to the user (e.g. a TV program).

The user's device can request the manifest e.g. from first server 130 and/or from server 100.

A non-limitative example of the manifest 1000 for the next thirty seconds is described in FIG. 10.

In this non-limitative example, manifest 1000 comprises three chunks (Chunk 1, Chunk 2, Chunk 3), each of a duration of 10 seconds. Each chunk comprises an Internet link enabling the media player of the user's device to sequentially play each piece of media content accessible using each Internet link.

Assume that it is desired to insert, after “Chunk 3”, a media content (in this example, an ad content). The decision of inserting an ad content at this specific place within manifest 1000 can be taken e.g. by server 100. In some embodiments, insertion of an ad content can comprise replacing an existing chunk of the manifest by the ad content (for example, the existing chunk comprises an ad content, and the existing chunk is replaced by another chunk including a personalized ad content, targeted to the user, which includes an enrichment content).

Server 100 communicates with the second server 141 (in this example, an ad server) and requests an ad content. In response to this request, second server 141 transmits to server 100 an ad content (see reference 148), together with enrichment data (see reference 147). In this example, second server 141 transmits an XMIL file comprising an ad content “ad_for_fresh_drinks.mp4” advertising for a company which sells fresh drinks, together with an enrichment content.

Server 100 parses the XML file (which is encoded in this example according to the VAST standard) and detects tag(s) indicative of a VAST function which makes the ad content played by the media player clickable. The corresponding tags are <ClickThrough> (beginning of the VAST function) and </ClickThrough> (end of the VAST function).

Between the two tags in the XML file, the XML file includes an Internet address http://www.fresh-drink-company.com which corresponds to the link which should be accessed when a user clicks on the ad content.

Server 100 detects that the user's device has a media player which is of the HLS.js type. This can be detected e.g. based on the requests sent by the user's device to get the manifest, as explained above.

Server 100 searches in a database (such as database 420—this is, however, not limitative) for a software module which meets two conditions:
the software module enables making the screen of a media player clickable; and
the software module is executable by a media player of the HLS.js type.

As a consequence, server 100 extracts a first software module from the database which meets these two conditions. In this non-limitative example, the first software module is a template which enables access to a link when a user clicks on the screen of the HLS.js type. A non-limitative example of the first software module is provided hereinafter:

```
let videoClicks = metaData.data ? JSON.parse(metaData.data) : null;
  if(videoClicks && videoClicks._uri){
    ampClickThrough = function( ){
    window.open(videoClicks._uri);
    };
  }
  document.querySelector(″.amp-interactive″).classList.add(′amp-share′)
  ampClickableEle.addEventListener(″click″, ampClickThrough);
  amp.react.container.appendChild(ampClickableEle);
metaData.data {
“uri” = http://www.fresh-drink-company.com
}
```

In this template, the variable “metaData.data” corresponds to a portion of the software module in which the value(s) of the variable part(s) of the executable code is (are) to be defined. In particular, in this non-limitative example, the variable “uri” which corresponds to the Internet link accessed by the user who clicks on the ad content is set equal to http://www.fresh-drink-company.com. The software module is packed in a JSON file by server 100.

Server 100 performs transcoding of the file “ad_for_fresh_drinks.mp4”. In this non-limitative example, the ad content is to be read by a smartphone (the second server 141 transmitted this information). Therefore, file ad_for_fresh_drinks.mp4 is transcoded into a transcoded media content with the following properties, which are compliant with a smartphone (these values are not limitative):
Resolution: 1280×720 HD;
Audio type: AAC;
Frame per Sec: 50;
Bitrate: 1.5 Mbps.

Server 100 creates PSI tables of a MPEG file including the transcoded ad content and the software module. A PAT table and a PMT table are created. The PAT table points to the PMT table. In the PMT table, the video stream carries the video content of the transcoded media content, the audio stream carries the audio content of the transcoded media content, and the metadata stream carries the JSON file created by server 100.

Server 100 updates the manifest 1000 and inserts a new chunk (chunk 4). The new chunk (chunk 4) comprises a link to the MPEG file. An updated manifest 1010 is therefore obtained, as is visible in FIG. 10A.

The updated manifest 1010 is transmitted to the user's device.

The media player of the user's device executes sequentially the chunks of the manifest 1010. When it reaches chunk 4, it accesses the MPEG file using the link of chunk 4. The media player reads the PAT table which points to the PMT table. The PMT table indicates that the MPEG file comprises three channels, each referenced by a different ID number (as shown in FIG. 7). The media player plays the video content transmitted on the video channel and the audio content transmitted on the audio channel. The listener of the media player listens to the metadata channel and executes the JSON file transmitted on this metadata channel.

As a consequence, when the user watches the ad content, the screen of the HLS.js media player is made clickable. When he clicks on the screen, this opens the Internet link http://www.fresh-drink-company.com.

As explained beforehand, in some embodiments, the ad content can be enriched with different enrichment contents.

For example, in some embodiments, in addition to the software module enabling access to the Internet link http//www.fresh-drink-company.com, an additional software module enabling monitoring of the clicks of the user can be transmitted. Therefore, when the user clicks on the ad content, this can be monitored and corresponding information can be transmitted e.g. to server 100. In some embodiments, server 100 generates a report informative of the number of times users have clicked on the ad content to access the Internet link. This can be used e.g. to handle a billing process of the second server 141 based on the number of clicks.

It is to be noted that the various features described in the various embodiments may be combined according to all possible technical combinations.

It is to be understood that the invention is not limited in its application to the details set forth in the description contained herein or illustrated in the drawings. The invention is capable of other embodiments and of being practiced and carried out in various ways. Hence, it is to be understood that the phraseology and terminology employed herein are for the purpose of description and should not be regarded as limiting. As such, those skilled in the art will appreciate that the conception upon which this disclosure is based may readily be utilized as a basis for designing other structures, methods, and systems for carrying out the several purposes of the presently disclosed subject matter.

Those skilled in the art will readily appreciate that various modifications and changes can be applied to the embodiments of the invention as hereinbefore described without departing from its scope, defined in and by the appended claims.

1. A server comprising one or more processing circuitries configured to:
obtain a media content comprising at least one of an audio content and a video content,
obtain enrichment data informative of a given enrichment content associated with the media content,
for a computer-implemented media player of a first media player type, use the media content and the enrichment data to generate augmented data, wherein the augmented data comprises:
data informative of the media content, playable by the media player of the first media player type, and
a software module executable by the media player of the first media player type, wherein execution of at least part of the software module by the media player enables execution of the given enrichment content by the media player.

2. The server of claim 1, wherein the software module comprises an executable code, wherein execution of at least part of the executable code by the media player of the first media player type enables execution of the given enrichment content by the media player.

3. The server of claim 1, wherein the one or more processing circuitries are configured to:
obtain a media content comprising at least one of an audio content and a video content,
obtain enrichment data informative of a given enrichment content associated with the media content,
for each given user device of a plurality of different user devices, obtaining information on a given type of a media player implemented at the given user device, wherein at least two user devices implement a media player of a different type,
for each given type of media player, use the media content and the enrichment data to generate augmented data, wherein the augmented data comprises:
data informative of the media content, playable by a media player of the given media player type,
a software module executable by a media player of the given media player type, wherein execution of at least part of the software module by the media player enables execution of the given enrichment content by the media player.

4. The server of claim 1, configured to perform a textual analysis of the enrichment data to detect at least one predefined function informative of said given enrichment content.

5. The server of claim 1, configured to:
obtain data informative of a main media content comprising at least one of an audio content and a video content,
obtain a media content comprising at least one of an audio content and a video content, wherein a duration of the media content is below a predefined threshold,
obtain enrichment data informative of a given enrichment content associated with the media content,
for a computer-implemented media player of a first media player type, use the media content and the enrichment data to generate augmented data, wherein the augmented data comprises:
data informative of the media content, playable by the media player of the first media player type,
a software module executable by the media player of the first media player type,
wherein execution of at least part of the software module by the media player enables execution of the given enrichment content by the media player, and insert data informative of the augmented data within the data informative of the main media content.

6. (canceled)

7. The server of claim 1, wherein the one or more processing circuitries are operative to communicate with a database, storing, for each given media player type of a plurality of different media player types of media players, a given software module adapted to said given media player type,
wherein, for a computer-implemented media player of the first media player type, the one or more processing circuitries are configured to:
obtain the software module using a first software module of the database, wherein the first software module is adapted to the first media player type,
wherein execution of at least part of the software module by the media player enables execution of the enrichment content by the media player.

8. The server of claim 1, wherein data information of the media content and the software module are enabled to be transmitted as interlaced data within a transport stream transmitted to the media player.

9. The server of claim 1, wherein:
the or more processing circuitries are operative to communicate with a database storing, for each given type of enrichment content of a plurality of types of enrichment content, a given software module enabling the media player of the first media player type to execute an enrichment content of the given type of enrichment content,
wherein the given enrichment content is of a first type of enrichment content,
wherein the or more processing circuitries are configured to perform at least one of (i), (ii) or (iii):
(i) obtain the software module using a first software module of the database, wherein the first software module is adapted to the first type of enrichment content, wherein execution of at least part of the software module by the media player enables execution of the given enrichment content by the media player,
(ii) extract a first software module from the database, wherein the software module corresponds to the first software module;
(iii) extract a first software module from the database and generate the software module using the first software module and enrichment data.

10. (canceled)

11. The server of claim 1, configured to generate the augmented data using a format enabling transmitting:
(i) at least one of a video or audio content, and
(ii) metadata,
wherein the data informative of the media content is transmitted as at least one of video or audio content of said formate, and the software module is transmitted as metadata of said format.

12. The serve of claim 1, wherein:
the one or more processing circuitries are operative to communicate with a database storing, for each given media player type of a plurality of different media player types and for each given type of enrichment content of a plurality of types of enrichment content, a given software module enabling a media player of the given media player type to execute an enrichment content of the given type of enrichment content,
wherein the given enrichment content is of a first type of enrichment content,
wherein the one or more processing circuitries are configured to perform at least one of (i), (ii) or (iii):
(i) obtain the software module using a first software module of the database, wherein the first software module is adapted to the first media player type and to the first type of enrichment content, wherein execution of at least part of the software module by the media player enables execution of the given enrichment content by the media player.
(ii) extract a first software module from the database, wherein the software module corresponds to the first software module;
(iii) extract a first software module from the database and generate the software module using the first software module and the enrichment data.

13. (canceled)

14. The server of claim 1, wherein the one or more processing circuitries are configured to determine that a media player of a user, to which the media content and the given enrichment content, or data informative thereof, is to be transmitted, is of the first media player type.

15. The server of claim 1, wherein the augmented data comprises MPEG data, wherein the MPEG data comprises the data informative of the media content and metadata storing the software module.

16. The server of claim 1, wherein the one or more processing circuitries are configured to transmit the augmented data, or data enabling access to the augmented data, to the media player of the first media player type, wherein the augmented data stores the software module as metadata, wherein the media player of the first media player type is operative to execute metadata in the augmented data.

17. The server of claim 1, wherein execution of at least part of the software module by the media player of the first media player type of a user enables execution of the given enrichment content by the media player, wherein execution of the given enrichment content enables at least one of: (i) interaction with the user, or (ii) monitoring of a behavior of the user during playing of the media content by the media player.

18. (canceled)

19. (canceled)

20. (canceled)

21. The server of claim 1, wherein at least one of (i) or (ii) is met: (i) the given enrichment content is not encoded according to a Video Ad Serving Template and is not encoded according to Video Player-Ad Interface Definition, (ii) the media content comprises advertisement content.

22. The server of claim 1, wherein the one or more processing circuitries are configured to:
obtain data informative of a main media content to be streamed, the main media content comprising at least one of a video content and an audio content,
insert, within the data, data informative of the augmented data, to obtain updated data.

23. The server of claim 1, wherein the media player of the first media player type is operative to execute a computer-implemented function enabling:
detection of the software module in the augmented data, and
execution of said software module.

24. The server of claim 1, wherein the one or more processing circuitries are operative to communicate with a database storing, for each given media player type of a plurality of different media player types and for at least one given type of enrichment content, a given software module enabling a media player of the given media player type to execute an enrichment content of the given type of enrichment content, wherein the one or more processing circuitries are operative to update the database to store, for each given media player type of the plurality of different media player types, for a new type of enrichment content, a new software module enabling a media player of the given media player type to execute an enrichment content of the new type of enrichment content.

25-48. (canceled)

49. A non-transitory computer readable medium comprising instructions that, when executed by one or more processing circuitries cause the one or more processing circuitries to perform:
obtaining a media content comprising at least one of an audio content and a video content,
obtaining enrichment data informative of a given enrichment content associated with the media content,
for a computer-implemented media player of a first media player type, using the media content and the enrichment data to generate augmented data, wherein the augmented data comprises:
data informative of the media content, playable by the media player of the first media player type,
a software module executable by the media player of the first media player type, wherein execution of at least part of the software module by the media player enables execution of the given enrichment content by the media player.

50. A non-transitory computer readable medium comprising instructions that, when executed by one or more processing circuitries, cause the one or more processing circuitries to perform:
receiving, by a media player of a given media player type, augmented data comprising:
a media content playable by the media player of the given media player type, wherein the media content comprises at least one of an audio content and a video content,
a software module informative of a given enrichment content, wherein the software module comprises an executable code executable by the media player of the given media player type,
playing the media content by the media player, and
executing at least part of the executable code by the media player, wherein execution of the executable code by the media player enables execution of the given enrichment content by the media player.
